(19) United States
(12) Patent Application Publication
(10) Pub. No.: US 2016/0241845 A1
(43) Pub. Date: Aug. 18, 2016

(54) DOUBLE-VISION DISPLAY AND DOUBLE-VISION DISPLAYING METHOD

(71) Applicant: BOE TECHNOLOGY GROUP CO., LTD., Beijing (CN)

(72) Inventor: Yanbing WU, Beijing (CN)

(21) Appl. No.: 15/135,031

(22) Filed: Apr. 21, 2016

Related U.S. Application Data
(63) Continuation of application No. 13/701,662, filed on Dec. 3, 2012.

(30) Foreign Application Priority Data
Jul. 7, 2011 (CN) 201110189479.4

(51) Int. Cl. H04N 13/04; G09G 3/00

(52) U.S. Cl. CPC H04N 13/0409; G09G 3/003; G09G 2300/0447; G09G 2310/062; G09G 2320/0209; G09G 2320/0247

(57) ABSTRACT

Embodiments of the invention provide a double-vision display and a double-vision displaying method. The double-vision display comprises a first display plane for displaying a first content and a second display plane for displaying a second content, the first display plane comprises a plurality of first display units, the second display plane comprises a plurality of second display units, and the first display units and the second display units are alternately arranged. The method comprises: when the first display plane of a display panel of the double-vision display displays a first image of the first content, the second display plane of the display panel displaying one black image; and when the second display plane displays a second image of the second content, the first display plane displaying one black image; the first images of the first content and the second images of the second content are temporally alternately displayed.

### TECHNICAL FIELD

Embodiments of the invention relate to a double-vision display and a double-vision displaying method.

### BACKGROUND

A double-vision display can display different contents (images) in different regions of a same screen for viewers positioned at different view angles with respect to the display. A parallax barrier method is one of the common technologies to achieve the double-vision displaying effect, the structure of which is shown in FIG. 1. The double-vision display 10 comprises a display panel 1 and a parallax barrier 2 disposed above (in front of) the display panel 1. The parallax barrier 2 is an optical member comprising transparent stripes and light-shielding stripes that are arranged alternately. The basic mechanism of the double-vision displaying is that: a viewer M positioned on the left side of the display watches only a portion of sub-pixels (sub-pixels shown in a shadow portion in the drawing) on the display through the parallax barrier, and a viewer N positioned on the right side of the display only watches the rest portion of the sub-pixels (sub-pixels shown in a non-shallow portion in the drawing) on the display through the parallax barrier. Thus, when different image signals are respectively provided to the sub-pixels watched only by the viewer M on the left side and the sub-pixels watched only by the viewer N on the right side, a double-vision effect can be achieved.

During the double-vision displaying of the double-vision display of the conventional technology, crosstalk definitely occurs between adjacent sub-pixels to some extent, and the crosstalk result in a disadvantageous influence on the double-vision effect. As shown in FIG. 2, a voltage difference between a common electrode 3 and a pixel electrode 4 of each sub-pixel determines orientation of liquid crystal molecules between the two electrodes, and light transmittance is affected at last. During the double-vision displaying, a first sub-pixel 5 is for displaying an image A, and a second sub-pixel 6 adjacent to the first sub-pixel 5 is for displaying an image B. The images A and B may be for displaying possibly completely different pictures; however, because the distance between the pixel electrode 4 of the first sub-pixel 5 and the pixel electrode of the second sub-pixel 6 adjacent to the first sub-pixel 5 is relatively small, capacitance is definitely generated between the pixel electrode of the first sub-pixel 5 and the pixel electrode of the second sub-pixel 6 so that crosstalk occurs between the adjacent sub-pixels. This will leads to the phenomenon in which the displayed images may partially or completely overlap, and the displaying effect of the double-vision display is adversely influenced.

### SUMMARY

Embodiments of the invention provide a double-vision display and a double-vision displaying method, for avoiding crosstalk between two images during double-vision displaying and improving the display effect of the double-vision display.

An embodiment of the invention provides a displaying method of a double-vision display, the double-vision display comprising a first display plane and a second display plane. The first display plane comprises a plurality of first display units, the second display plane comprises a plurality of second display units, and the first display units and the second display units are alternately arranged. The method comprises:

when the first display plane displays a first image, the second display plane displaying one black image; and

when the second display plane displays a second image, the first display plane displaying one black image,

wherein first images of a first content and second images of a second content are temporally alternately displayed.

Another embodiment of the invention further provides a double-vision display comprises:

a display panel comprising a first display plane and a second display plane, wherein the first display plane comprises a plurality of first display units, the second display plane comprises a plurality of second display units, and the first display units and the second display units are alternately arranged; and

a display driving module, being adapted, at a certain timing, for driving the first display plane of the display panel to display a first image and driving the second display plane of the display panel to display one black image; and at a next timing, for driving the first display plane to display one black image and driving the second display plane to display a second image, and then repeating the above procedure over time.

In an embodiment of the invention, the first images and the second images which are respectively displayed for viewers positioned at different view angles with respect to the display are separately displayed over time during double-vision displaying; however, in the conventional technology, the first images and the second images are simultaneously displayed during double-vision displaying, which leads to crosstalk between sub-pixels for displaying the first images and the adjacent sub-pixels for displaying the second images. In the embodiment of the invention, the first images and the second images are temporally separated and individually displayed, and thus crosstalk between the first images and the second images can be avoided; the black images inserted during separately displaying the first images and second images do not give rise to perceivable crosstalk with the first images and second images for a viewer, and therefore, compared with the conventional technology, the displaying effect can be significantly improved by using the double-vision display and the displaying method according to the embodiment of the invention.

### BRIEF DESCRIPTION OF THE DRAWINGS

In order to clearly illustrate the technical solution of the embodiments of the invention or that of a conventional technology, the drawings of the embodiments will be briefly described in the following; it is obvious that the described drawings are only related to some embodiments of the invention; based on these drawings, those skilled in the art can obtain other drawings without inventive work.

FIG. 1 is a schematic view for showing a conventional double-vision display;

FIG. 2 is a structural schematic view of adjacent sub-pixels;

FIG. 3 is a structural schematic view of a double-vision display plane in an embodiment of the invention;

FIG. 4 is a structural schematic view of the double-vision display plane while a first image is displayed in an embodiment of the invention;

FIG. 5 is a structural schematic view of the double-vision display plane while a second image is displayed in an embodiment of the invention; and

FIG. 6 is a schematic view for showing states in which the first image and the second image are temporally alternately displayed.

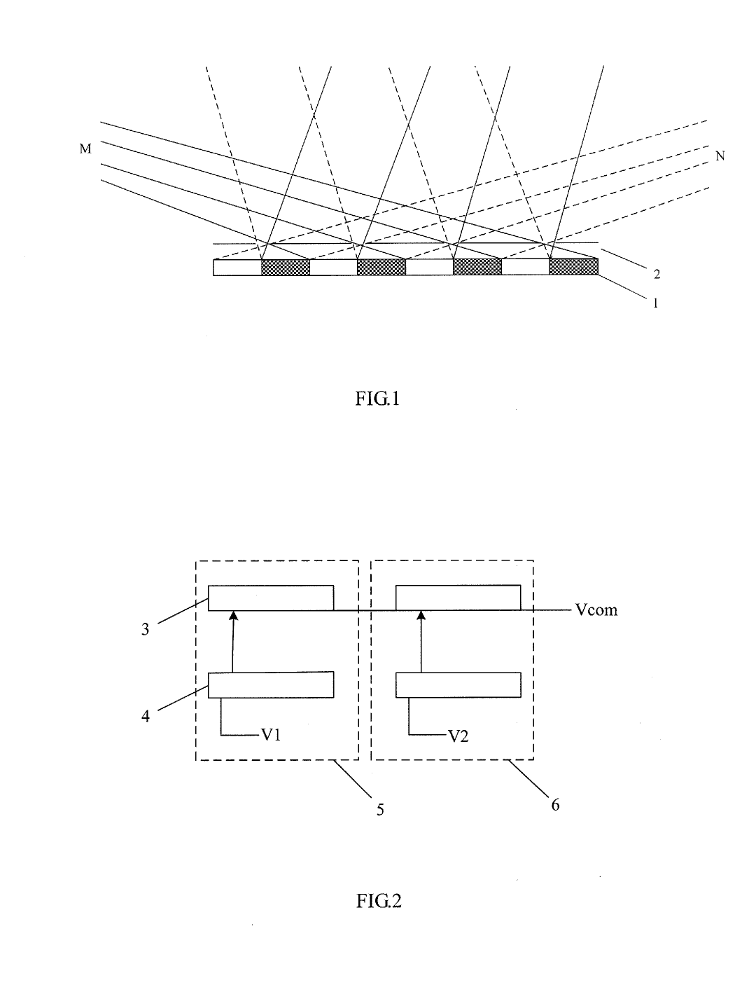

### DETAILED DESCRIPTION

The technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

An embodiment of the invention provides a double-vision display and a double-vision displaying method, crosstalk between two images can be avoided during double-vision displaying, and the displaying effect of a double-vision display can be improved.

### First Embodiment

This embodiment of the invention provides a displaying method of a double-vision display, the double-vision display comprises a display panel and the display panel comprises a first display plane for displaying a first content and a second display plane for displaying a second content. The first and second display contents may be different from each other, for example, different movies for different viewers. Each of the displayed first and second contents comprises multiple images or pictures that are presented continuously in timing. The method is conducted as follows.

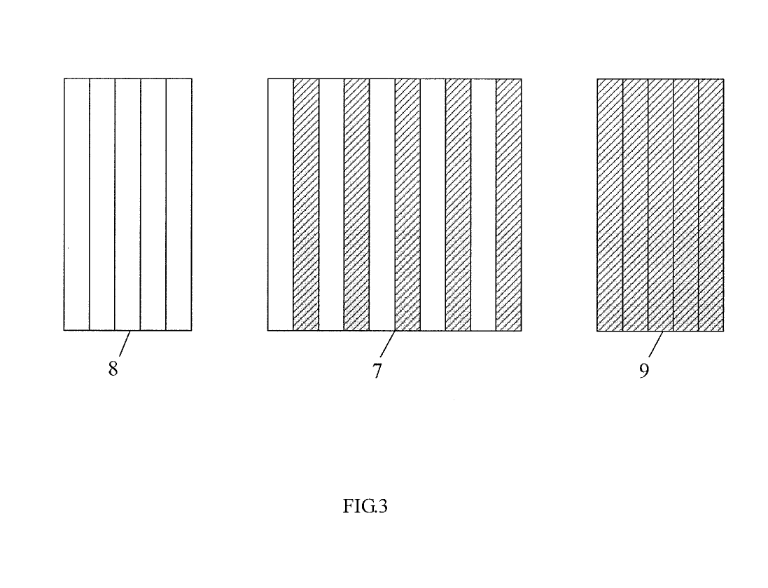

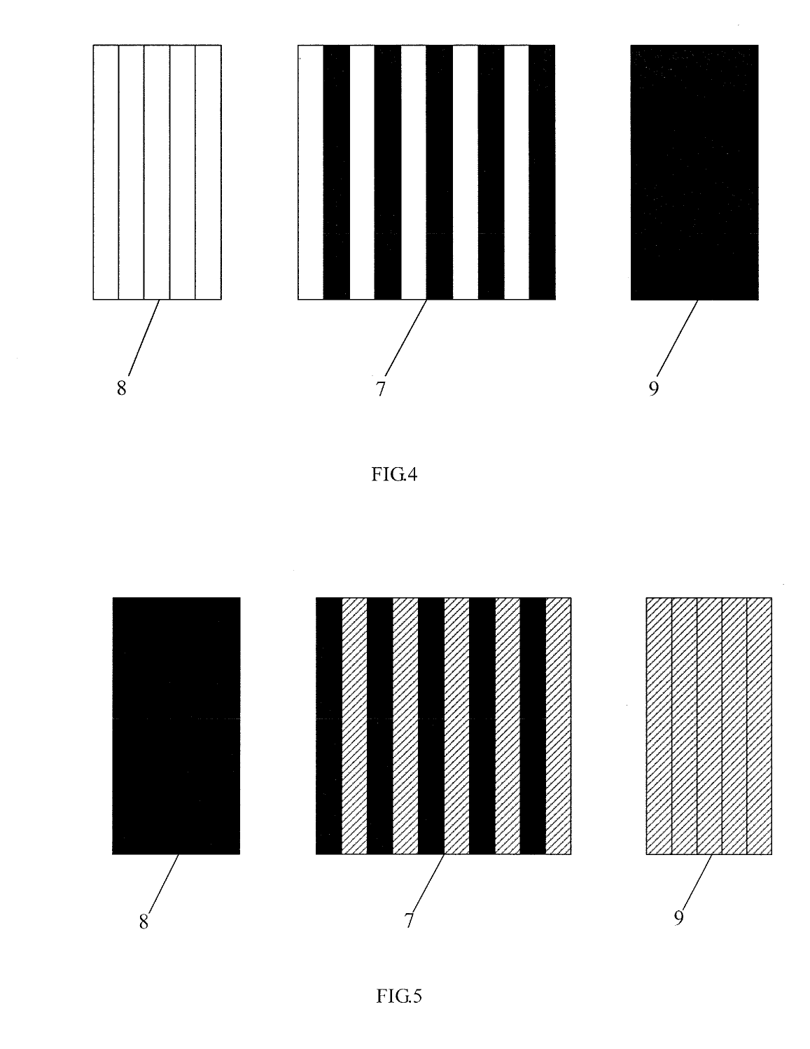

When the first display plane displays one image of the first content (a first image), the second display plane displays one black image, and when the second display plane displays one image of the second content (a second image), the first display plane displays one black image, and the first images of the first content and the second images of the second content are temporally alternately displayed. The first display plane comprises a plurality of first display units, the second display plane comprises a plurality of second display units, and the first display units and the second display units are alternately arranged. A first display unit and a second display unit each may comprise one or more sub-pixels. As shown in FIG. 3, in the embodiment of the invention, a double-vision display plane 7 of the double-vision display is formed by alternately arranging a plurality of columns of a first display plane 8 and a plurality of columns of a second display plane 9, each column of the first display plane 8 is composed of one or more the first display units, and each column of the second display plane 9 is composed of one or more the second display units; therefore, the first display units and the second display units are alternately arranged. As shown in FIG. 4, when the first display plane 8 displays one first image, the second display plane 9 displays one black image.

When the first display units display one first image and the second display units adjacent to the first display units display one black image, a crosstalk occurs between the sub-pixels positioned adjacent to the boundary between the first display units and the second display units, that is, the black image may give rise to crosstalk with respect to the first image; however, because the black image uniformly gives rise to crosstalk with respect to the first image as a whole, and the crosstalk of the black image to the first image is hardly perceived by a viewer.

In the embodiment of the invention, a gray scale value of the black image is preferably “0.” Because the desired images and the black image are temporally alternately displayed on a display plane when a viewer is watching the display, if the black image is not sufficiently dark, the displaying effect of the desired images for the viewer may be disadvantageously influenced, and thus, the gray scale value of the black image is preferably “0” so as to ensure a contrast ratio of the images. Herein, the contrast ratio is equal to a ratio between white brightness and black brightness.

As shown in FIG. 5, when the second display plane 9 displays one second image, the first display plane 8 displays one black image, and a gray scale value of the black image may preferably “0.”

With the embodiment of the invention, the first images and the second images are temporally separated during displaying, so that crosstalk between the first images and the second images can be avoided.

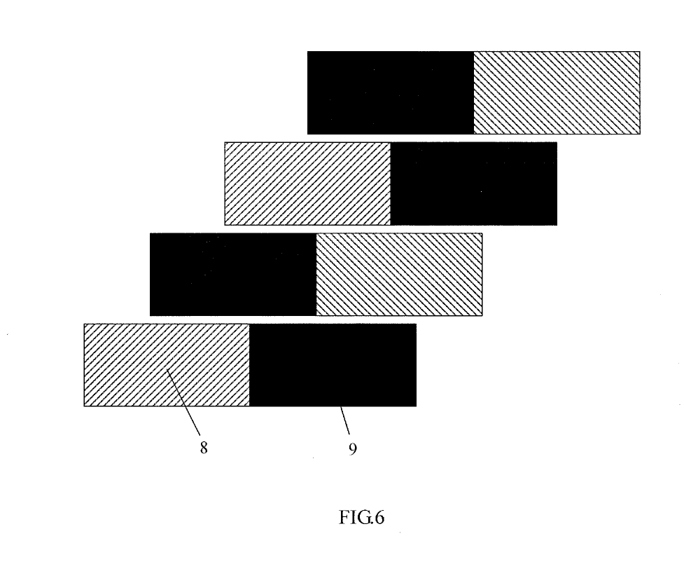

As shown in FIG. 6, a schematic view in which the first display plane 8 and the second display plane 9 display images at four sequential timings is provided. At one timing, the first display plane 8 displays one first image while the second display plane 9 displays one black image; at a next timing, the first display plane 8 is switched to display one black image while the second display plane 9 is switched to display one second image; subsequently, the above displaying operations in the two proceeding timings for the first display plane 8 and the second display plane 9 are repeated, so that the first images of the first content and the second images of the second content are temporally alternately displayed. Because the black images are inserted in the double-vision displaying, the desired images and the black images are temporally alternately displayed on the first and second display plane when a viewer is watching the display, and the refreshing frequencies of the first display plane and the second display plane are preferably more than 120 Hz; a display with a refreshing frequency larger than 120 Hz can be used in order to prevent a viewer from perceiving a screen-flicking.

With the embodiment of the invention, the first images and the second images which are respectively received by viewers positioned at different view angles with respect to the display are separately displayed over time during double-vision displaying; in contrast, in the conventional technology, the first images and the second images are simultaneously displayed, which leads to crosstalk between sub-pixels for displaying the first images and adjacent sub-pixels for displaying the second images. In the embodiment of the invention, the first images and the second images are temporally separated and individually displayed, and when the sub-pixels for displaying the first content display one first image, the adjacent sub-pixels for displaying the second content display one black image, and when the adjacent sub-pixels for displaying the second content displays one second image, the sub-pixels for displaying the first content display one black image, and thus, crosstalk between the first images and the second images can be avoided. The crosstalk of the black images, which are inserted during separately displaying of the first images and the second images, to the first images or the second images is hardly perceived by a viewer; therefore, compared with the conventional technology, the displaying effect can be significantly improved by using the displaying method according to an embodiment of the invention.

### Second Embodiment

An embodiment of the invention provides a double-vision display, and the double-vision display comprises a display panel and a display driving module.

The display panel comprises a first display plane for displaying a first content and a second display plane for displaying a second content. The first display plane comprises a plurality of first display units, the second display plane comprises a plurality of second display units, and the first display units and the second display units are alternately arranged.

The display driving module is adapted, at a certain timing, for driving the first display plane of the display panel to display an image of the first content (a first image) and driving the second display plane of the display panel to display one black image, and at a next timing, for driving the first display plane to display a black image and driving the second display plane to display an image of the second content (a second image). Subsequently, the above procedure is repeated over time.

At a first timing, the display driving module drives the first image plane to display a first image, and at the same time the second image plane displays a black image; at a second timing the display driving module drives the first image plane to display a black image, and at the same time the second image plane displays a second image; in the subsequent timings, the display driving module repeat the above driving procedure to alternately display the first image and second image.

The double-vision display according to the embodiment of the invention may further include a parallax barrier disposed above (in front of) the display panel.

In an embodiment of the invention, a gray scale value of the black image is preferably “0.” Because the desired images and the black images are temporally alternately displayed on a display plane when a viewer is watching the display, and if the black images are not sufficiently dark, the displaying effect of the content watched by the viewer may be disadvantageous influenced, and thus, the gray scale value of the black image is preferably 0 to ensure a desired contrast ratio of the images. In addition, the refreshing frequencies of the first display plane and the second display plane may be preferably more than 120 Hz, and a display with a refreshing frequency larger than 120 Hz may be used in order to prevent a viewer from perceiving a screen-flicking.

With the embodiment of the invention, the first images and the second images which are respectively received by viewers positioned at different view angles with respect to the display are separately displayed over time during double-vision displaying; in contrast, in the conventional technology, the first images and the second images are simultaneously displayed, which leads to crosstalk between sub-pixels for displaying the first images and adjacent sub-pixels for displaying the second images. In the embodiment of the invention, the first images and the second images are temporally separated and individually displayed, and when the sub-pixels for displaying first images display one first image, the adjacent sub-pixels for displaying second images display one black image, and when the adjacent sub-pixels for displaying the second images displays one second image, the sub-pixels for displaying the first images display one black image, and thus, crosstalk between the first images and the second images can be avoided. The crosstalk of the black images, which are inserted during separately displaying of the first images and the second images, to the first images or the second images is hardly perceived by a viewer; therefore, compared with the conventional technology, the displaying effect can be significantly improved by using the displaying method according to an embodiment of the invention.

In the embodiments of the invention, the used display panel may be a liquid crystal display panel, an organic light-emitting diode panel, plasma display panel, e-ink display panel and the like. In the case of a display crystal panel, as described above, a first display plane for displaying a first content and a second display plane for displaying a second content are formed; the first display plane and the second display plane are on a same level, and the columns of the first display plane and the second display plane are alternately arranged, and each column comprises one or more pixel units.

The embodiments of the invention being thus described above, but the protection scope of the invention is not limited thereto; variations and substitutes, which can be easily conceived by those skilled in the art within in the disclosure of the invention, should be within the protection scope of the invention. The protection scope of the invention should be defined by the scope of the following claims.

1. A displaying method of a double-vision display, the double-vision display comprises a display panel comprising a first display unit and a second display unit, the first display unit comprises a plurality of first pixels, the second display unit comprises a plurality of second pixels, the first pixels and the second pixels are alternately arranged, and the method comprises:
when the first pixels of the display panel display a first image, the second pixels of the display panel display a black image;
when the second pixels display a second image, the first pixels display the black image, wherein the first image and the second image are alternately displayed.

2. The displaying method according to the claim 1, wherein a refreshing frequency of the first image and the second image is equal to or larger than 120 Hz.

3. The displaying method according to the claim 1, wherein a gray scale value of the black image is 0.

4. The displaying method according to the claim 1, wherein a parallax barrier is disposed above the display panel.

5. A double-vision display; comprising:
a display panel, comprising a first display unit for displaying a first content and a second display unit for displaying a second content, wherein the first display unit comprises a plurality of first pixels, the second display unit comprises a plurality of second pixels, and the first pixels and the second pixels are alternately arranged; and
a display driving module, being adapted, at a certain timing, for driving the first pixels of the display panel to display a first image of the first content and driving the second pixels of the display panel to display one black image; and at a next timing, for driving the first pixels to display one black image and driving the second pixels to display a second image of the second content, and then repeating the above procedure over time.

6. The double-vision display according to the claim 5, wherein a refreshing frequency of the first image and the second image is larger than 120 Hz

7. The double-vision display according to the claim 5, wherein a gray scale value of the black image is 0.

8. The double-vision display according to the claim 5, wherein a parallax barrier is disposed above the display panel.

9. The double-vision display according to the claim 5, wherein the display panel is a liquid crystal display panel, an organic light-emitting diode panel, plasma display panel or e-ink display panel.
